(19) United States
(12) Patent Application Publication
(10) Pub. No.: US 2020/0103809 A1
(43) Pub. Date: Apr. 2, 2020

(54) MEDIUM CUTTING DEVICE, MEDIUM FEEDING DEVICE, AND IMAGE FORMING APPARATUS

(71) Applicant: Oki Data Corporation, Tokyo (JP)

(72) Inventor: Daichi SATO, Tokyo (JP)

(73) Assignee: Oki Data Corporation, Tokyo (JP)

(21) Appl. No.: 16/572,073

(22) Filed: Sep. 16, 2019

(30) Foreign Application Priority Data
Sep. 28, 2018 (JP) 2018-183673

(51) Int. Cl. G03G 15/00; B65H 20/06; B65H 35/06; B65H 35/00

(52) U.S. Cl. CPC G03G 15/6523; B65H 35/0086; B65H 35/06; B65H 20/06

(57) ABSTRACT

A medium cutting device includes first and second conveying sections and a cutting section. The first conveying section conveys a continuous medium having a perforation that extends in a first direction. The first conveying section conveys the continuous medium in a second direction intersecting the first direction. The second conveying section is spaced from the first conveying section in the second direction, and conveys the continuous medium in the second direction. The cutting section includes a pressing member and a supporting member. The pressing member is movable in the first direction in a gap between the first and second conveying sections. The supporting member movably supports the pressing member in the second direction. The cutting section causes the pressing member to press the continuous medium while causing the pressing member to move in the first direction, thereby cutting the continuous medium at the perforation.

### CROSS REFERENCE TO RELATED APPLICATIONS

The present application claims priority from Japanese Patent Application No. 2018-183673 filed on Sep. 28, 2018, the entire contents of which are hereby incorporated by reference.

### BACKGROUND

The technology relates to an image forming apparatus that forms an image by an electrophotographic method, a medium feeding device mountable on the image forming apparatus, and a medium cutting device mountable on the image forming apparatus.

A medium cutting device or any other device has been proposed that cuts a continuous medium, having a perforation, at the perforation. The continuous medium having the perforation may be hereinafter simply referred to as a perforation medium. For example, reference can be made to Japanese Unexamined Patent Application Publication Nos. 2007-069277, 2001-205598, 2000-335031, and H07-100798.

### SUMMARY

It may be desired for a medium cutting device, that cuts a perforation medium at its perforation, to accurately cut the perforation medium at a desired position.

It is desirable to provide a medium cutting device that is able to cut a perforation medium with higher accuracy, a medium feeding device, and an image forming apparatus.

According to one embodiment of the technology, there is provided a medium cutting device that includes a first conveying section, a second conveying section, and a cutting section. The first conveying section conveys a continuous medium having a perforation extending in a first direction. The first conveying section conveys the continuous medium in a second direction that intersects the first direction. The second conveying section is spaced from the first conveying section in the second direction. The second conveying section conveys the continuous medium in the second direction. The cutting section includes a pressing member and a supporting member. The pressing member is movable in the first direction in a gap between the first conveying section and the second conveying section. The supporting member movably supports the pressing member in the second direction. The cutting section causes the pressing member to press the continuous medium while causing the pressing member to move in the first direction and thereby cuts the continuous medium at the perforation.

According to one embodiment of the technology, there is provided a medium feeding device mounted on or mountable on an image forming apparatus provided with an image forming section. The medium feeding device feeds, to the image forming section, a continuous medium having a perforation extending in a first direction. The medium feeding device includes a medium feeding section, a first conveying section, a second conveying section, and a cutting section. The medium feeding section feeds the continuous medium. The first conveying section conveys the continuous medium in a second direction that intersects the first direction. The second conveying section is spaced from the first conveying section in the second direction. The second conveying section conveys the continuous medium in the second direction. The cutting section includes a pressing member and a supporting member. The pressing member is movable in the first direction in a gap between the first conveying section and the second conveying section. The supporting member movably supports the pressing member in the second direction. The cutting section causes the pressing member to press the continuous medium while causing the pressing member to move in the first direction and thereby cuts the continuous medium at the perforation.

According to one embodiment of the technology, there is provided an image forming apparatus that includes an image forming section and a medium feeding device. The medium feeding device feeds, to the image forming section, a continuous medium having a perforation extending in a first direction. The medium feeding device includes a medium feeding section, a first conveying section, a second conveying section, and a cutting section. The medium feeding section feeds the continuous medium. The first conveying section conveys the continuous medium in a second direction that intersects the first direction. The second conveying section is spaced from the first conveying section in the second direction. The second conveying section conveys the continuous medium in the second direction. The cutting section includes a pressing member and a supporting member. The pressing member is movable in the first direction in a gap between the first conveying section and the second conveying section. The supporting member movably supports the pressing member in the second direction. The cutting section causes the pressing member to press the continuous medium while causing the pressing member to move in the first direction and thereby cuts the continuous medium at the perforation.

### BRIEF DESCRIPTION OF DRAWINGS

FIG. 1A is a schematic diagram illustrating an example of an overall configuration of an image forming apparatus according to an example embodiment of the technology.

FIG. 1B is a block diagram illustrating an example of a configuration of a control mechanism in an image forming apparatus illustrated in FIG. 1A.

FIG. 2 is a perspective view of an example of an overall configuration of a medium cutting section illustrated in FIG. 1A.

FIG. 3A is a perspective view of an example of an overall configuration of a cutter section illustrated in FIG. 2.

FIG. 3B is a top view of an example of the overall configuration of the cutter section illustrated in FIG. 2.

FIG. 3C is a front view of an example of the overall configuration of the cutter section illustrated in FIG. 2.

FIG. 4A is a first perspective view of the medium cutting section illustrated in FIG. 1A and illustrates an example of conveying operation of the medium cutting section.

FIG. 4B is a second perspective view of the medium cutting section illustrated in FIG. 1A and illustrates an example of the conveying operation of the medium cutting section.

FIG. 5A is a first front view of the medium cutting section illustrated in FIG. 1A and illustrates an example of cutting operation of the medium cutting section.

FIG. 5B is a second front view of the medium cutting section illustrated in FIG. 1A and illustrates an example of the cutting operation of the medium cutting section.

FIG. 6A is a third front view of the medium cutting section illustrated in FIG. 1A and illustrates an example of the cutting operation of the medium cutting section.

FIG. 6B is a fourth front view of the medium cutting section illustrated in FIG. 1A and illustrates an example of the cutting operation of the medium cutting section.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail. The description will be given in the following order.

### 1. EXAMPLE EMBODIMENT

A medium feeding device and an image forming apparatus each provided with a cutter that cuts a continuous medium having a perforation.

### 2. MODIFICATION EXAMPLES

### 1. Example Embodiment

### Overall Configuration of Image Forming Apparatus

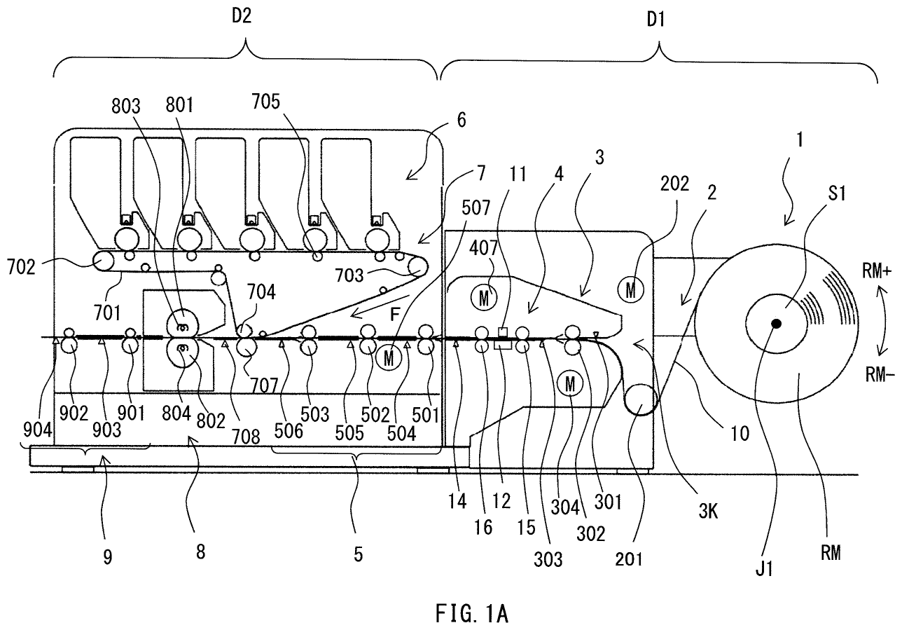

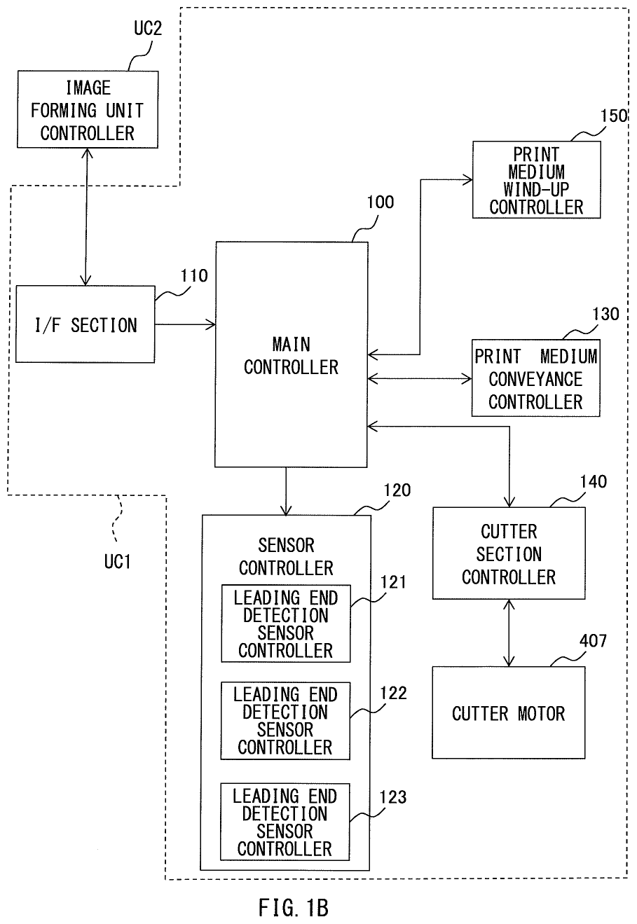

FIG. 1A schematically illustrates an example of an overall configuration of an image forming apparatus according to an example embodiment of the technology. The image forming apparatus may be, for example, an electrophotographic printer that forms an image such as a color image on a continuous medium 10. Non-limiting examples of the continuous medium 10 may include continuous paper provided with a perforation 10A in a width direction. The perforation 10A will be described later. The continuous medium 10 may be, for example, wound up to provide a roll (a wound-up structure) RM. Herein, the perforation may refer to a plurality of cut portions that are discretely arranged in a width direction that is approximately perpendicular to a feeding direction of the continuous medium 10, i.e., a conveyance direction of the continuous medium 10. The cut portions may run through the continuous medium 10 in a thickness direction. In one example embodiment, the cut portions may be arranged with pitches that are substantially the same as each other.

As illustrated in FIG. 1A, the image forming apparatus may include, for example, a medium feeding unit D1 and an image forming unit D2. The medium feeding unit D1 may rotatably hold the roll RM. The roll RM may be the wound-up continuous medium 10 which is a target of image formation. The medium feeding unit D1 may feed the continuous medium 10 toward the image forming unit D2 provided downstream of the medium feeding unit D1 when printing operation is performed. The medium feeding unit D1 may correspond to a “medium feeding device” in one specific but non-limiting embodiment of the technology. The image forming unit D2 may transfer a developer image, e.g., a toner image, onto the continuous medium 10 fed from the medium feeding unit D1, and fix the transferred developer image to the continuous medium 10. The image forming unit D2 may correspond to an “image forming section” in one specific but non-limiting embodiment of the technology.

The medium feeding unit D1 may include, for example, a medium feeding section 1, a medium introducing section 2, a medium conveying section 3, and a medium cutting section 4 that are disposed in order from upstream to downstream. The image forming unit D2 may include, for example, a write-timing adjusting and conveying section 5, an image forming section 6, an intermediate transfer section 7, a fixing section 8, and a discharging and conveying section 9 that are disposed in order from the upstream to the downstream.

The continuous medium 10 fed from the medium feeding section 1 may be conveyed in order of the medium introducing section 2, the medium conveying section 3, the medium cutting section 4, the write-timing adjusting and conveying section 5, the image forming section 6, and the intermediate transfer section 7, the fixing section 8, and the discharging and conveying section 9. It is to be noted that, as used herein, the term “upstream” refers to a position closer to the medium feeding section 1, which is a feeding source of the continuous medium 10, compared with any position in a traveling direction of the continuous medium 10, i.e., a direction in which the continuous medium 10 travels. The term “downstream” refers to a position farther from the medium feeding section 1, compared with any position in the traveling direction of the continuous medium 10. As used herein, the term “width direction” refers to a direction perpendicular to the traveling direction of the continuous medium 10, i.e., a direction perpendicular to the paper plane of FIG. 1A.

The medium feeding section 1 may hold the roll RM and feed the continuous medium 10 toward the medium introducing section 2. The medium feeding section 1 may include a shaft S1 that holds the roll RM. Rotation of the shaft S1 with a rotational shaft J1 as a center of rotation, for example, in a rotational direction RM+ may cause the continuous medium 10 to be unwound from the roll RM. The medium introducing section 2 may introduce the continuous medium 10 unwound from the roll RM of the medium feeding section 1 into the image forming unit D2. The medium introducing section 2 may include a tension roller 201 and a wind-up motor 202. The tension roller 201 may be a rotary member that applies constant tension to the continuous medium 10 unwound from the roll RM and thereby prevents slack of the continuous medium 10. The wind-up motor 202 may generate driving force that causes the shaft S1 to rotate in a rotational direction RM−. Further, the shaft S1 may be provided with a torque limiter mechanism, that is, a mechanism that idles when a load equal to or higher than a preset rotation torque is applied to the roll RM. The torque limiter mechanism may prevent the rotational torque generated by the wind-up motor 202 in the rotational direction RM− from being applied to the roll RM more than necessary.

The medium conveying section 3 may include, for example, a leading end detection sensor 301, a pair of feeding rollers 302, and a leading end detection sensor 303 in order from upstream toward downstream. The leading end detection sensors 301 and 303 may each be a position detection sensor that detects a leading end of the continuous medium 10. When the leading end detection sensor 301 detects the continuous medium 10, the pair of feeding rollers 302 may start driving and thereby feed the continuous medium 10 toward the downstream. The conveyance motor 304 may drive the pair of feeding rollers 302 under control of the medium conveyance controller 130 which will be described later.

The medium cutting section 4 may include, for example, a cutter section 11, a travel guide 12, a pair of upstream conveying rollers 15, a pair of downstream conveying rollers 16, and a leading end detection sensor 14. The cutter section 11 may cut the continuous medium 10. The travel guide 12 may be a table on which the continuous medium 10 is placed and which guides traveling of the continuous medium 10. The pair of upstream conveying rollers 15 may be positioned upstream of the cutter section 11. The pair of upstream conveying rollers 15 may convey the perforation 10A of the continuous medium 10 to a predetermined position, on the travel guide 12, at which cutting by the cutter section 11 is allowed to be performed. The above-described predetermined position may be referred to as a cutting target position. The pair of downstream conveying rollers 16 may be positioned downstream of the cutter section 11. The pair of downstream conveying rollers 16 may convey a medium piece toward the write-timing adjusting and conveying section 5 positioned downstream of the pair of downstream conveying rollers 16. The medium piece may be a piece cut from the continuous medium 10 by the cutter section 11. The leading end detection sensor 14 may detect a position of the leading end of the continuous medium 10 conveyed from the pair of downstream conveying rollers 16. The pair of upstream conveying rollers 15 and the pair of downstream conveying rollers 16 may be driven by a conveyance motor 304. The cutter section 11 may correspond to a “cutting section” in one specific but non-limiting embodiment of the technology. The travel guide 12 may correspond to a “guide” in one specific but non-limiting embodiment of the technology. The pair of upstream conveying rollers 15 may correspond to a “first conveying section” in one specific but non-limiting embodiment of the technology. The pair of downstream conveying rollers 16 may correspond to a “second conveying section” in one specific but non-limiting embodiment of the technology. A detailed configuration of the medium cutting section 4 will be described later.

The write-timing adjusting and conveying section 5 positioned downstream of the medium cutting section 4 may convey the medium piece cut from the continuous medium 10 toward a secondary transfer roller 707 in the intermediate transfer section 7 while adjusting timing of conveying the medium piece. The secondary transfer roller 707 will be described later. The write-timing adjusting and conveying section 5 may include, for example, a pair of timing adjusting rollers 501, a pair of timing adjusting rollers 502, and a pair of timing adjusting rollers 503 in order from the upstream. The medium cutting section 4 may further include, for example, a leading end detection sensor 504, a leading end detection sensor 505, and a leading end detection sensor 506. The leading end detection sensor 504 may be disposed downstream of the pair of timing adjusting rollers 501. The leading end detection sensor 505 may be disposed downstream of the pair of timing adjusting rollers 502. The leading end detection sensor 506 may be disposed downstream of the pair of timing adjusting rollers 503. The write-timing adjusting and conveying section 5 may further include a conveyance motor 507 that drives the pairs of timing adjusting rollers 501 to 503. The pairs of timing adjusting rollers 501 to 503 may each convey the medium piece while adjusting a conveying speed and timing. The leading end detection sensors 504 to 506 may each detect a position of a leading end of the conveyed medium piece.

The image forming section 6 may be disposed on upper side of the intermediate transfer section 7. The image forming section 6 may include developing devices that each form a toner image of a corresponding color. The image forming section 6 may form the toner images of respective colors on a surface of an intermediate transfer belt 701 of the intermediate transfer section 7 by an electrophotographic method. The intermediate transfer belt 701 will be described later.

The intermediate transfer section 7 may include, for example, the intermediate transfer belt 701, a drive roller 702, a tension roller 703, a secondary transfer backup roller 704, a primary transfer roller 705, a secondary transfer roller 707, and a medium slack sensor 708. The intermediate transfer belt 701 may be an endless elastic belt including a resin material such as polyimide resin, for example. The intermediate transfer belt 701 may lie on members including the drive roller 702, the tension roller 703, and the secondary transfer backup roller 704, while being stretched. The drive roller 702 may be driven by a drive motor and thereby cause the intermediate transfer belt 701 to rotate in a predetermined conveyance direction F. The tension roller 703 may be a driven roller driven in accordance with rotation of the intermediate transfer belt 701. The tension roller 703 may apply tension to the intermediate transfer belt 701 with use of biasing force from a biasing member such as a coil spring. The primary transfer roller 705 may be opposed to the image forming section 6 with the intermediate transfer belt 701 interposed therebetween. The primary transfer roller 705 may apply a predetermined voltage when the toner image formed by the developing device is transferred onto the surface of the intermediate transfer belt 701. The secondary transfer backup roller 704 and the secondary transfer roller 707 may be disposed on opposite side to the image forming section 6, i.e., at a lower portion of the intermediate transfer section 7. The secondary transfer backup roller 704 and the secondary transfer roller 707 may be opposed to each other with the intermediate transfer belt 701 interposed therebetween and thereby provide a secondary transfer section. The secondary transfer backup roller 704 and the secondary transfer roller 707 may transfer, onto the medium piece, the toner image that has been transferred onto the surface of the intermediate transfer belt 701. In other words, the secondary transfer backup roller 704 and the secondary transfer roller 707 may perform secondary transfer of the above-described toner image that has been subjected to the primary transfer. Upon the secondary transfer of the toner image onto the medium piece, the intermediate transfer section 7 may cause timing of the foregoing secondary transfer to be synchronized with timing at which the image forming section 6 forms the toner image on the intermediate transfer belt 701. The intermediate transfer section 7 may perform the above-described synchronization with use of the write-timing adjusting and conveying section 5. The medium slack sensor 708 may be disposed downstream of the secondary transfer section. The medium slack sensor 708 may detect slack of the medium piece conveyed between the secondary transfer section and the fixing section 8.

The fixing section 8 may be disposed downstream of the intermediate transfer section 7. The fixing section 8 may apply heat and pressure to the toner image transferred onto the medium piece conveyed from the secondary transfer section including the secondary transfer backup roller 704 and the secondary transfer roller 707. The fixing section 8 may thereby melt the toner image, and fix the toner image to the medium piece. The fixing section 8 may include a pair of rollers 801 and 802, a heat source 803, and a heat source 804. The pair of rollers 801 and 802 may be in contact with each other at a predetermined pressure. The heat source 803 may be built in the roller 801 and heat the roller 801. The heat source 804 may be built in the roller 802 and heat the roller 802. The heat sources 803 and 804 may each be, for example, a halogen lamp.

The discharging and conveying section 9 may be disposed downstream of the fixing section 8. The discharging and conveying section 9 may include a pair of conveying rollers 901, a pair of conveying rollers 902, a medium detection sensor 903, and a medium detection sensor 904. The pairs of conveying rollers 901 and 902 may each discharge the medium piece conveyed from the fixing section 8 to outside of the image forming unit D2. The medium detection sensors 903 and 904 may each detect the medium piece conveyed from the fixing section 8 and to be discharged to the outside of the image forming unit D2.

### Control Mechanism of Image Forming Apparatus

FIG. 1B is a block diagram illustrating an example of a configuration of a control mechanism of the image forming apparatus illustrated in FIG. 1A. As illustrated in FIG. 1B, the image forming apparatus according to an example embodiment may include a medium feeding unit controller UC1 and an image forming unit controller UC2. The medium feeding unit controller UC1 may include a main controller 100, an initial controller 101, a non-volatile memory controller 102, an I/F section 110, a sensor controller 120, a medium conveyance controller 130, a cutter section controller 140, and a medium wind-up controller 150.

The main controller 100 may control general operation of the medium feeding unit D1. The I/F section 110 may exchange a signal with the image forming unit controller UC2. The I/F section 110 may decode a command from, for example, the image forming unit controller UC2, and thereafter decode a command to notify the main controller 100 of the command from the image forming unit controller UC2. Non-limiting examples of the command from the image forming unit controller UC2 may include a request to convey the continuous medium 10 or the medium piece.

The sensor controller 120 may include leading end detection sensor controllers 121 to 123. The leading end detection sensor controllers 121 to 123 may respectively cause the leading end detection sensor 301, the leading end detection sensor 303, and the leading end detection sensor 14 to execute detection of the leading end of the continuous medium 10 or the medium piece. The leading end detection sensor controllers 121 to 123 may thereafter each notify the main controller 100 of leading end detection information, i.e., information related to detection of the leading end described above. The main controller 100 may calculate a medium conveyance speed at the upstream of the cutter section 11 on the basis of the leading end detection information. The main controller 100 may thereafter notify the medium conveyance controller 130 of the leading end detection information and medium conveyance speed information, i.e., information related to the calculated medium conveyance speed.

The medium conveyance controller 130 may acquire the medium conveyance speed information from the main controller 100. The medium conveyance controller 130 may set, on the basis of the acquired medium conveyance speed information, a rotation speed and a rotation amount of the conveyance motor 304. In a specific but non-limiting example, when the leading end detection sensor 303 detects the leading end of the continuous medium 10 prior to cutting, the pair of upstream conveying rollers 15 and the pair of downstream conveying rollers 16 may be driven by the conveyance motor 304 and thereby start rotating. Further, when the leading end detection sensor 14 detects the leading end of the continuous medium 10 conveyed from the pair of downstream conveying rollers 16, the medium conveyance controller 130 may so cause the conveyance motor 304 to rotate that the continuous medium 10 is conveyed by a predetermined conveyance amount. The medium conveyance controller 130 may thereafter temporarily stop the conveyance motor 304. In the above-described manner, the pair of upstream conveying rollers 15 and the pair of downstream conveying rollers 16 may convey the continuous medium 10 toward the downstream by a predetermined conveyance amount from the leading end position of the continuous medium 10. The pair of upstream conveying rollers 15 and the pair of downstream conveying rollers 16 may thereby cause the position of the perforation 10A to reach a predetermined cutting target position in the cutter section 11. As a result, the continuous medium 10 may be sandwiched by the pair of upstream conveying rollers 15 and the pair of downstream conveying rollers 16 while the perforation 10A is at the predetermined cutting target position. The medium conveyance controller 130 may swiftly notify the main controller 100 of a fact that the medium conveyance controller 130 has caused the conveyance motor 304 to so rotate as to convey the continuous medium 10 by the predetermined conveyance amount from the leading end detection position and thereafter temporarily stopped the conveyance motor 304. The medium conveyance controller 130 may promptly notify the main controller 100 of the above-described fact as cutting target position stop information.

The cutter section controller 140 may control operation of the cutter section 11. In a specific but non-limiting example, the cutter section controller 140 may control the operation of the cutter motor 407 on the basis of an instruction given from the main controller 100. The cutter section controller 140 may acquire the cutting target position stop information from the main controller 100, and drive the cutter motor 407 on the basis of the cutting target position stop information. Driving of the cutter motor 407 may cause the cutter section 11 to cut the continuous medium 10 at the perforation 10A.

The medium wind-up controller 150 may start the wind-up motor 202 on the basis of an instruction given from the main controller 100. The medium wind-up controller 150 may cause the shaft S1 of the medium feeding section 1 to so rotate in the rotational direction RM− as to wind up the continuous medium 10 unwound from the roll RM. The above-described operation may reduce or eliminate slack in the continuous medium 10 and provide appropriate tension to the continuous medium 10.

### Configuration of Cutter Section 11

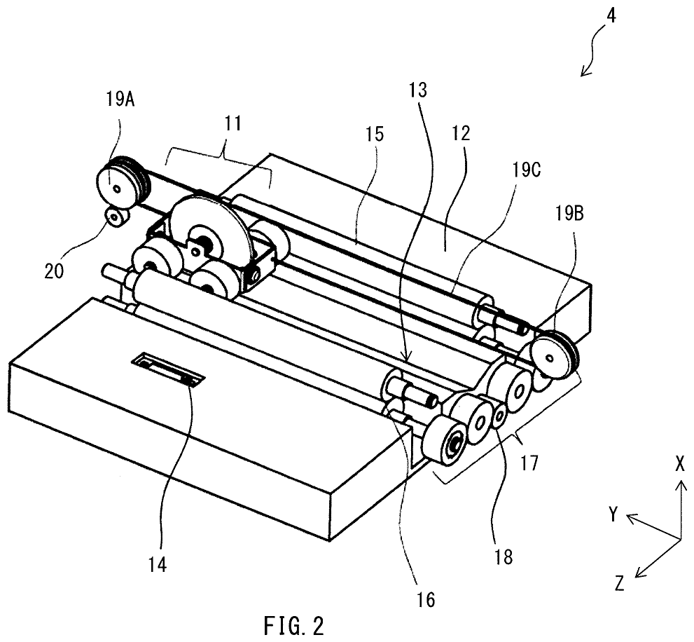

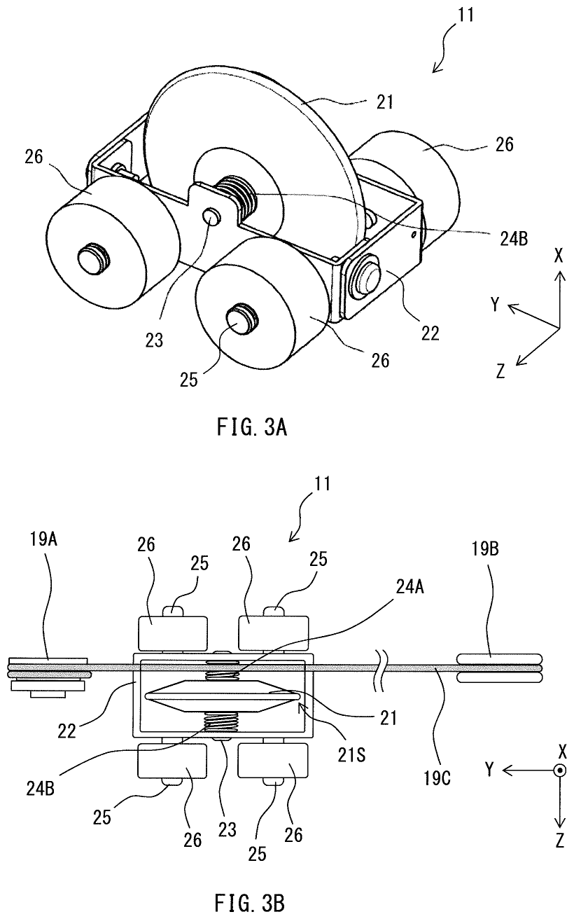

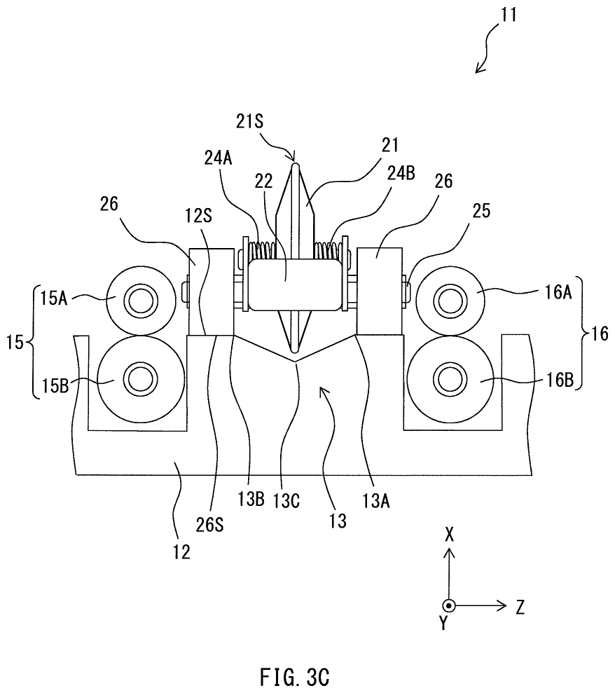

FIG. 2 is a perspective view of an example of an overall configuration of the medium cutting section 4 including the cutter section 11. FIGS. 3A to 3C are a perspective view, a top view, and a front view of an example of the cutter section 11, respectively. Herein, in the medium cutting section 4, a thickness direction of the continuous medium 10 is defined as an X-axis direction, a conveyance direction of the continuous medium 10 is defined as a Z-axis direction, and a width direction of the continuous medium 10 is defined as a Y-axis direction. Further, a downstream conveyance direction of the continuous medium 10 is defined as a −Z direction, and an upstream conveyance direction of the continuous medium 10 is defined as a +Z direction.

As illustrated in FIG. 2, the cutter section 11 may travel on the travel guide 12 in the Y-axis direction in the medium cutting section 4. The travel guide 12 may be a guide positioned on opposite side of the continuous medium 10 to a cutter 21. The cutter 21 will be described later. The travel guide 12 may include an upper surface 12S, i.e., a surface on which the continuous medium 10 is to be placed. The upper surface 12S may have, for example, a groove 13. The groove 13 may have, for example, a V-shaped cross-section and extend, for example, in the Y-axis direction. The groove 13 may correspond to the cutting target position at which the continuous medium 10 is to be cut. The groove 13 may correspond to a “depression” in one specific but non-limiting embodiment of the technology. The cutter section 11 may be opposed to the groove 13 in the X-axis direction. The cutter section 11 may travel above the groove along the groove 13.

The pair of upstream conveying rollers 15 may be positioned upstream of the cutter section 11. The pair of upstream conveying rollers 15 may include a conveying roller 15A and a conveying roller 15B that are opposed to each other in the X-axis direction. The pair of downstream conveying rollers 16 may be positioned downstream of the cutter section 11. The pair of downstream conveying rollers 16 may include a conveying roller 16A and a conveying roller 16B that are opposed to each other in the X-axis direction. In one example embodiment, a height position of the conveying roller 15A and the conveying roller 15B, i.e., a position, in the X-axis direction, at which the conveying roller 15A and the conveying roller 15B are in contact with each other, may be substantially the same as that of the upper surface 12S of the travel guide 12. Hereinafter, the position in the X-axis direction may be also referred to as a height position. Similarly, in one example embodiment, a height position at which the conveying roller 16A and the conveying roller 16B are in contact with each other may be substantially the same as the height position of the upper surface 12S of the travel guide 12. In the above-described case, a plane coupling a first contact position and a second contact position to each other may be a plane including the upper surface 12S of the travel guide 12. The first contact position may be a height position at which the conveying roller 15B and the continuous medium 10 come into contact with each other. The second contact position may be a height position at which the conveying roller 16B and the continuous medium 10 come into contact with each other. A conveyance gear train 17 and a conveyance motor gear 18 may be provided, for example, on a side surface of the travel guide 12. The conveyance motor gear 18 may mesh with a portion of the conveyance gear train 17. The conveyance motor gear 18 may receive driving force from the conveyance motor 304. The driving force from the conveyance motor 304 may be therefore transmitted to each of the pair of upstream conveying rollers 15 and the pair of downstream conveying rollers 16 via the conveyance motor gear 18 and the conveyance gear train 17.

The medium cutting section 4 may further include a pulley gear 19A, a pulley 19B, a wire 19C, and a cutter motor gear 20.

As illustrated in FIGS. 3A to 3C, the cutter section 11 may include the cutter 21 serving as a pressing member. The cutter 21 may be a rotary blade including a tip 21S that is to be opposed to the groove 13. The cutter 21 may be so attached to a frame 22 that the cutter 21 is rotatable with a shaft 23 as a center of rotation. The cutter 21 may intersect with the plane including the upper surface 12S of the travel guide 12. In other words, a height position of the tip 21S may be lower than the height position of the upper surface 12S. The tip 21S may come into contact with a surface 1051 of the continuous medium 10 when the continuous medium 10 is conveyed to the upper surface 12S of the travel guide 12. The groove 13 in the travel guide 12 may have a first edge 13A, a second edge 13B, and a deepest portion 13C. The first edge 13A may be positioned between the tip 21S and the pair of upstream conveying rollers 15 in an X-Z cross-section. The second edge 13B may be positioned between the tip 21S and the pair of downstream conveying rollers 16 in the X-Z cross-section. The deepest portion 13C may be positioned between the first edge 13A and the second edge 13B in the X-Z cross-section. The groove 13 may be provided by an inclined surface coupling the first edge 13A and the deepest portion 13C to each other, and an inclined surface coupling the second edge 13B and the deepest portion 13C to each other. The first edge 13A and the second edge 13B may both come into contact with a rear surface 10S2 of the continuous medium 10.

The cutter 21 may be so provided as to be movable in the Z-axis direction on a shaft 23. The shaft 23 may run through a central portion of the cutter 21 in the Z-axis direction. The cutter section 11 may include a pair of coil springs 24A and 24B through which the shaft 23 is inserted. The coil spring 24A and the coil spring 24B may be opposed to each other with the cutter 21 interposed therebetween in the Z-axis direction. The coil spring 24A and the coil spring 24B may bias the cutter 21 in respective directions opposite to each other. For example, the coil spring 24A may bias the cutter 21 in the +Z direction, and the coil spring 24B may bias the cutter 21 in the −Z direction. Therefore, the cutter 21 may be so biased as to be reversibly movable in the Z-axis direction, and may be stabilized at a position in accordance with external force. For example, four rollers 26 may be rotatably attached to the frame 22 via a shaft 25. The cutter section 11 may be so disposed that a surface 26S of the roller 26 is opposed to the upper surface 12S of the travel guide 12.

The cutter section 11 may be configured as follows to cut the continuous medium 10 at the perforation 10A. That is, the cutter 21 may move in the Y-axis direction while rotating with the shaft 23 as the center of rotation. This may cause the tip 21S to press the continuous medium 10 placed on the upper surface 12S of the travel guide 12, and to cut the continuous medium 10 at the perforation 10A. The cutter 21 may correspond to a “pressing member” and a “rotary member” in one specific but non-limiting embodiment of the technology. The shaft 23 may correspond to a “shaft” in one specific but non-limiting embodiment of the technology. A combination of the frame 22, the shaft 23, the shaft 25, and the roller 26 may correspond to a “supporting member” in one specific but non-limiting embodiment of the technology.

As illustrated in FIG. 2, the wire 19C may be attached to the frame 22 of the cutter section 11. The wire 19C may lie on the pulley gear 19A and the pulley 19B while being stretched. When the cutter motor gear 20 meshing with the pulley gear 19A is caused to rotate by the cutter motor 407 which is illustrated in FIG. 1B, the pulley gear 19A, the pulley 19B, and the wire 19C may rotate in conjunction with each other. As a result, the cutter section 11 may travel at the upper portion of the groove 13 in the Y-axis direction between the pair of upstream conveying rollers 15 and the pair of downstream conveying rollers 16.

### Medium Cutting Operation and Printing Operation

In the image forming apparatus, a medium piece may be cut from the continuous medium 10 and printing, i.e., toner image formation, may be performed on the cut medium piece in the following manner.

In a specific but non-limiting example, as illustrated in FIG. 1A, first, when the leading end of the continuous medium 10 pulled out from the roll RM held by the shaft S1 is inserted into a medium inlet 3K via the tension roller 201, the leading end detection sensor 301 may detect the leading end of the continuous medium 10. Accordingly, the pair of feeding rollers 302 may start rotational driving. This may cause the continuous medium 10 to be fed out from the roll RM and conveyed toward the medium cutting section 4 disposed downstream of the roll RM.

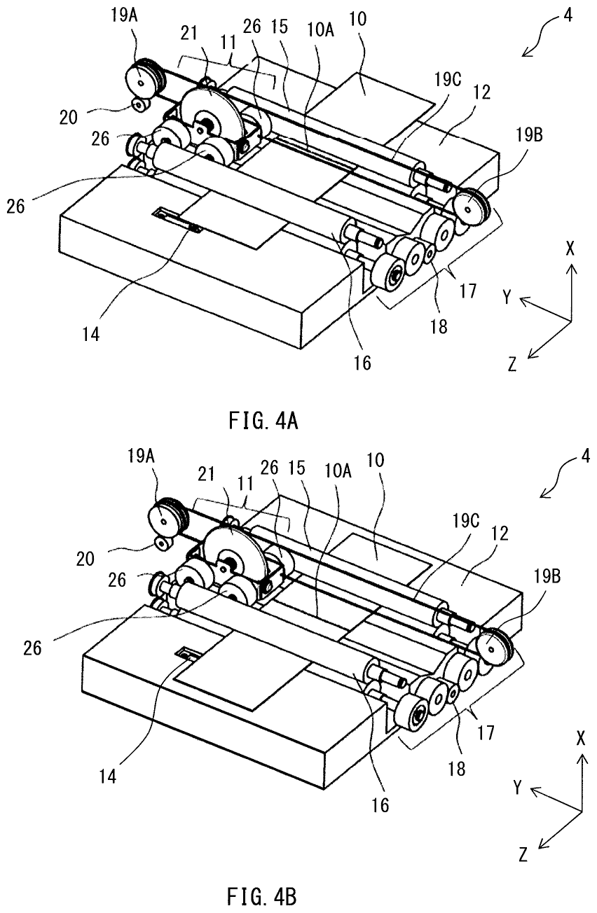

As illustrated in FIG. 4A, when the leading end detection sensor 14 detects the leading end position of the continuous medium 10 fed from the pair of feeding rollers 302, the pair of upstream conveying rollers 15 and the pair of downstream conveying rollers 16 may be driven by the conveyance motor 304 under the control of the medium conveyance controller 130. The pair of upstream conveying rollers 15 and the pair of downstream conveying rollers 16 may each be thereby rotated by a predetermined amount. This may cause the position of the perforation 10A to reach the predetermined cutting target position in the cutter section 11, as illustrated in FIG. 4B. Non-limiting examples of the predetermined cutting target position may include a position corresponding to the deepest portion 13C. The conveyance motor 304 may temporarily stop the conveyance of the continuous medium 10 at timing when the position of the perforation 10A reaches the cutting target position. The medium conveyance controller 130 may supply the cutting target position stop information to the main controller 100.

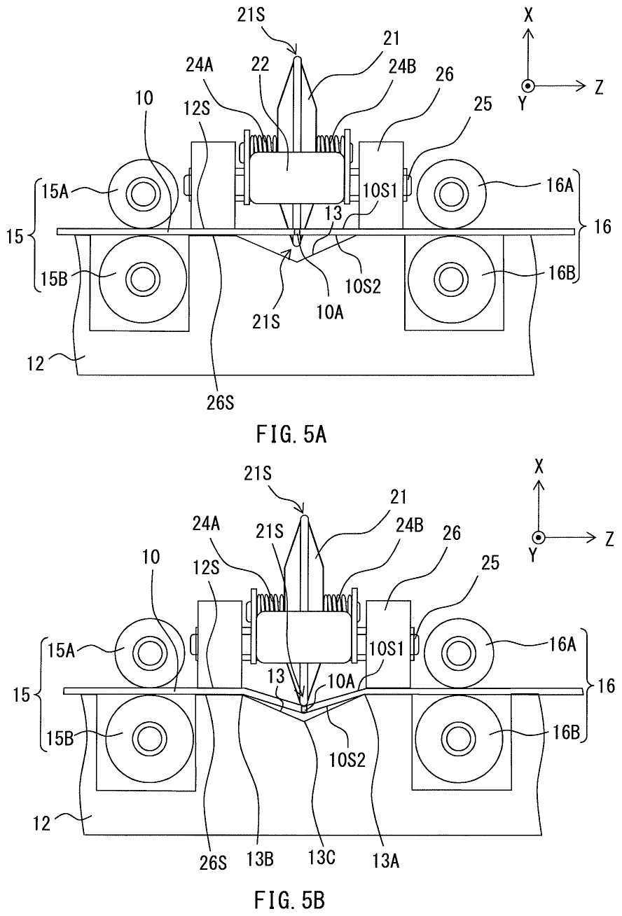

The continuous medium 10 conveyed to the medium cutting section 4 may be cut at the perforation 10A by the cutting operation performed by the cutter section 11 under the control by the cutter section controller 140. In one specific but non-limiting example, the cutter section 11 may so move in the Y-axis direction as to traverse the continuous medium 10 from a position deviated from the continuous medium 10 in the Y-axis direction, as illustrated in FIGS. 4B and 5A. The above-described movement of the cutter section 11 may be performed by driving of the cutter motor 407. Upon the above-described movement, the moving of the cutter section 11 in the Y-axis direction while rotating with the shaft 23 as the center of rotation may cause the tip 21S to press the surface 10S1 of the continuous medium 10 placed on the upper surface 12S of the travel guide 12 as illustrated in FIG. 5B. At this time, provision of the groove 13 may cause a portion, of the continuous medium 10, between the first edge 13A and the second edge 13B to be bent in a direction opposite to the tip 21S, i.e., the −X-direction. Since the continuous medium 10 may be held by the pair of upstream conveying rollers 15 and the pair of downstream conveying rollers 16, a predetermined tension may be applied to the portion, of the continuous medium 10, between the first edge 13A and the second edge 13B. As a result, the continuous medium 10 may be cut at the perforation 10A having lowest strength of the continuous medium 10.

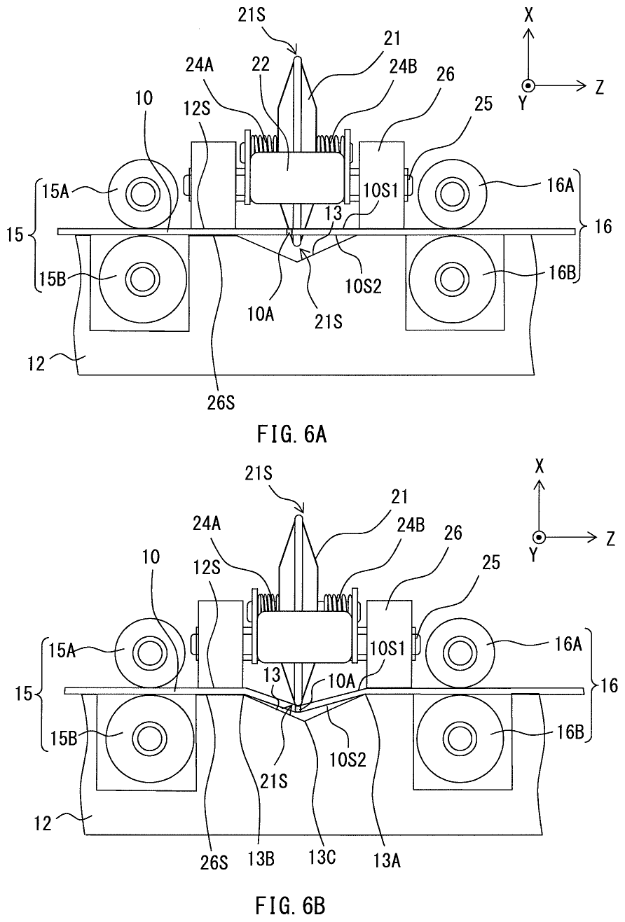

In the cutting operation described above, since the perforation 10A of the continuous medium 10 has the lowest strength, vicinity of the perforation 10A may be bent in the −X-direction most easily. According to the example embodiment, the cutter 21 may be so biased by the pair of coil springs 24A and 24B as to be reversibly movable in the Z-axis direction. Therefore, the tip 21S of the cutter 21 may so move in the Z-axis direction as to be closer to the vicinity of the perforation 10A which is to be bent most easily. The tip 21S of the cutter 21 may be stabilized at a position to which the tip 21S has moved. Accordingly, for example, as illustrated in FIG. 6A, even if the position of the tip 21S is slightly deviated from the position of the perforation 10A at timing when the continuous medium 10 is temporarily stopped, the position of the tip 21S and the position of the perforation 10A may substantially coincide with each other as illustrated in FIG. 6B when the cutter 21 traverses the continuous medium 10 in the Y-axis direction.

The medium piece cut in the medium cutting section 4 may be further conveyed toward the write-timing adjusting and conveying section 5 disposed downstream of the medium cutting section 4 by the rotational operation of the pair of downstream conveying rollers 16. The medium piece conveyed to the write-timing adjusting and conveying section 5 may be conveyed toward the secondary transfer section at appropriate timing. The secondary transfer section may include the secondary transfer backup roller 704 and the secondary transfer roller 707 that are opposed to each other.

In the image forming section 6 and the intermediate transfer section 7, toner images of respective colors may be formed by the following electrophotographic process. For example, a surface of a photosensitive drum may be electrically charged uniformly by a charging roller that receives a predetermined printing voltage. Thereafter, the surface of the photosensitive drum may be applied with illumination light from a light-emitting diode (LED) head and thereby exposed. An electrostatic latent image corresponding to a printing pattern may be thereby formed on the photosensitive drum. Thereafter, a toner may be adhered to the electrostatic latent image on the photosensitive drum from a developing roller. The toner on the photosensitive drum, i.e., a toner image, may be transferred onto the surface of the intermediate transfer belt 701 by an electric field provided between the photosensitive drum and the primary transfer roller 705 that is opposed to the photosensitive drum. Thereafter, the toner image on the surface of the intermediate transfer belt 701 may be transferred onto the medium piece in the secondary transfer section.

Thereafter, the toner on the medium piece, i.e., the toner image, may be applied with heat and pressure in the fixing section 8, and be thereby fixed to the medium piece. Thereafter, the medium piece to which the toner has been fixed may be discharged to the outside of the image forming unit D2 via the discharging and conveying section 9.

### Example Workings and Example Effects

As described above, in the example embodiment, the cutter 21 that cuts the continuous medium 10 at the perforation 10A may be so biased by the pair of coil springs 24A and 24B as to be reversibly movable in the medium conveyance direction, i.e., the Z-axis direction. This may cause the tip 21S of the cutter 21 to so move in the Z-axis direction as to be closer to the vicinity of the perforation 10A which is to be bent most easily, and cause the tip 21S to be stabilized at the position to which the tip 21S has been moved. Therefore, when the cutter 21 traverses the continuous medium 10 in the width direction, i.e., the Y-axis direction, the position of the tip 21S and the position of the perforation 10A substantially coincide with each other. This makes it possible to cut the continuous medium 10 at the perforation 10A with higher accuracy. As a result, an end surface of the cut medium piece is allowed to be a flat surface, for example, without tearing or chipping.

### 2. Modification Examples

Although the technology has been described with reference to some example embodiments, the technology is not limited to the example embodiments described above, and may be modified in a variety of ways. For example, in the example embodiments described above, the groove 13 having the V-shaped cross-section has been described as an example of the depression in the guide; however, the technology is not limited thereto. In one example embodiment, the depression in the guide may have a rectangular cross-section or a U-shaped cross-section. In the example embodiments described above, the cutter 21 which is a rotary blade has been described as an example of the pressing member; however, the technology is not limited thereto. In one example embodiment, the pressing member may be a non-rotary plate-shaped member or a non-rotary rod-shaped member.

In the example embodiments described above, the image forming apparatus that forms a color image has been described; however, the technology is not limited thereto. In one example embodiment, an image forming apparatus may transfer only a black toner image and thereby form a monochrome image.

In the example embodiments described above, the image forming apparatus having a printing function has been described as a specific but non-limiting example of the “image forming apparatus” of one embodiment of the technology; however, the technology is not limited thereto. For example, one embodiment of the technology is also applicable to an image forming apparatus that serves as a multifunction peripheral that has a function such as a scanning function, a facsimile function, or an image display function in addition to the printing function.

Furthermore, the technology encompasses any possible combination of some or all of the various embodiments and the modifications described herein and incorporated herein. It is possible to achieve at least the following configurations from the above-described example embodiments of the technology.

(1)

A medium cutting device including:

a first conveying section that conveys a continuous medium having a perforation, the perforation extending in a first direction, the first conveying section conveying the continuous medium in a second direction that intersects the first direction;

a second conveying section spaced from the first conveying section in the second direction, the second conveying section conveying the continuous medium in the second direction; and

a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.

(2)

The medium cutting device according to (1), in which the pressing member intersects a plane coupling a first contact position and a second contact position to each other, the first contact position being a position at which the first conveying section and the continuous medium come into contact with each other, the second contact position being a position at which the second conveying section and the continuous medium come into contact with each other, the pressing member being movable in the first direction.

(3)

The medium cutting device according to (1) or (2), in which

the pressing member includes a rotary member,

the supporting member includes a shaft that rotatably supports the rotary member, and

the rotary member is movable in the first direction while rotating with the shaft as a center of rotation.

(4)

The medium cutting device according to any one of (1) to (3), in which the cutting section further includes a biasing member that reversibly and movably biases the pressing member in the second direction.

(5)

The medium cutting device according to any one of (1) to (4), further including a guide having a depression, the guide being positioned between the first conveying section and the second conveying section and positioned on opposite side to the pressing member with the continuous medium interposed between the guide and the pressing member, the depression being provided at a position corresponding to a position of the pressing member.

(6)

The medium cutting device according to (5), in which

the pressing member includes a tip that is contactable with a surface of the continuous medium, and

the depression of the guide has a first edge and a second edge, the first edge being positioned between the tip and the first conveying section and being contactable with a rear surface of the continuous medium, the second edge being positioned between the tip and the second conveying section and being contactable with the rear surface of the continuous medium.

(7)

A medium feeding device mounted on or mountable on an image forming apparatus provided with an image forming section, the medium feeding device feeding, to the image forming section, a continuous medium having a perforation, the perforation extending in a first direction, the medium feeding device including:

a medium feeding section that feeds the continuous medium;

a first conveying section that conveys the continuous medium in a second direction that intersects the first direction;

a second conveying section spaced from the first conveying section in the second direction, the second conveying section conveying the continuous medium in the second direction; and

a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.

(8)

An image forming apparatus including:

an image forming section; and

a medium feeding device that feeds, to the image forming section, a continuous medium having a perforation, the perforation extending in a first direction,

the medium feeding device including

a medium feeding section that feeds the continuous medium,

a first conveying section that conveys the continuous medium in a second direction that intersects the first direction,

a second conveying section spaced from the first conveying section in the second direction, the second conveying section conveying the continuous medium in the second direction, and

a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.

According to the medium cutting device, the medium feeding device, and the image forming apparatus of one embodiment of the technology, it is possible to cut a perforation medium with higher accuracy.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A medium cutting device comprising:
a first conveying section that conveys a continuous medium having a perforation, the perforation extending in a first direction, the first conveying section conveying the continuous medium in a second direction that intersects the first direction;
a second conveying section spaced from the first conveying section in the second direction, the second conveying section conveying the continuous medium in the second direction; and
a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.

2. The medium cutting device according to claim 1, in which the pressing member intersects a plane coupling a first contact position and a second contact position to each other, the first contact position being a position at which the first conveying section and the continuous medium come into contact with each other, the second contact position being a position at which the second conveying section and the continuous medium come into contact with each other, the pressing member being movable in the first direction.

3. The medium cutting device according to claim 1, in which
the pressing member comprises a rotary member,
the supporting member includes a shaft that rotatably supports the rotary member, and
the rotary member is movable in the first direction while rotating with the shaft as a center of rotation.

4. The medium cutting device according to claim 1, in which the cutting section further includes a biasing member that reversibly and movably biases the pressing member in the second direction.

5. The medium cutting device according to claim 1, further comprising a guide having a depression, the guide being positioned between the first conveying section and the second conveying section and positioned on opposite side to the pressing member with the continuous medium interposed between the guide and the pressing member, the depression being provided at a position corresponding to a position of the pressing member.

6. The medium cutting device according to claim 5, in which
the pressing member includes a tip that is contactable with a surface of the continuous medium, and
the depression of the guide has a first edge and a second edge, the first edge being positioned between the tip and the first conveying section and being contactable with a rear surface of the continuous medium, the second edge being positioned between the tip and the second conveying section and being contactable with the rear surface of the continuous medium.

7. A medium feeding device mounted on or mountable on an image forming apparatus provided with an image forming unit, the medium feeding device feeding, to the image forming unit, a continuous medium having a perforation, the perforation extending in a first direction, the medium feeding device comprising:
a medium feeding section that feeds the continuous medium;
a first conveying section that conveys the continuous medium in a second direction that intersects the first direction;
a second conveying section spaced from the first conveying section in the second direction, the second conveying section conveying the continuous medium in the second direction; and
a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.

8. An image forming apparatus comprising:
an image forming unit; and
a medium feeding device that feeds, to the image forming unit, a continuous medium having a perforation, the perforation extending in a first direction,
the medium feeding device including
a medium feeding section that feeds the continuous medium,
a first conveying section that conveys the continuous medium in a second direction that intersects the first direction,
a second conveying section spaced from the first conveying section in the second direction, the second conveying section conveying the continuous medium in the second direction, and
a cutting section including a pressing member and a supporting member, the pressing member being movable in the first direction in a gap between the first conveying section and the second conveying section, the supporting member movably supporting the pressing member in the second direction, the cutting section causing the pressing member to press the continuous medium while causing the pressing member to move in the first direction and thereby cutting the continuous medium at the perforation.
